(19) United States
(12) Patent Application Publication
(10) Pub. No.: US 2024/0408808 A1
(43) Pub. Date: Dec. 12, 2024

(54) METHOD AND APPARATUS FOR FORMING PLASTIC PREFORMS INTO PLASTIC CONTAINERS

(71) Applicant: KRONES AG, Neutraubling (DE)

(72) Inventors: Markus KULZER, Zell (DE); Benedikt HENGL, Essing (DE); Daniel VOGLER, Neutraubling (DE)

(21) Appl. No.: 18/736,391

(22) Filed: Jun. 6, 2024

(30) Foreign Application Priority Data
Jun. 6, 2023 (DE) 102023114896.6

(51) Int. Cl. B29C 49/78; B29C 49/42; B29L 31/00

(52) U.S. Cl. CPC B29C 49/783; B29C 49/42845; B29C 49/4289; B29C 49/4205; B29C 2049/7832; B29L 2031/7158

(57) ABSTRACT

The method wherein plastic preforms are formed into plastic containers by application of a flowable medium wherein the plastic preforms are biased with different pressure levels and the flowable medium is stored in at least two reservoirs and is supplied from these reservoirs to the plastic preforms, wherein at least one of these reservoirs is supplied with the flowable medium by a pressure supply device and wherein the flowable medium is returned at least temporarily from the plastic container to at least one of these reservoirs, wherein a pressure in at least one reservoir is controlled, and wherein a target pressure is compared with an actual pressure in this reservoir, and a value characteristic of this comparison is determined.

### BACKGROUND OF THE INVENTION

The present invention relates to a method and an apparatus for forming plastic preforms into plastic containers. Such methods and apparatuses have long been known from the prior art. In this process, heated plastic preforms are usually expanded with a flowable medium and, in particular, with compressed air and thus formed into plastic containers and, in particular, plastic bottles. Compressed air reservoirs, such as ring channels, are usually used for this purpose. The expansion of the plastic preforms usually takes place in several pressure stages, starting with a lower initial pressure (P1), followed by an increased intermediate blowing pressure (PI) and an even higher final blowing pressure (P2).

In the prior art, the pressure levels of the blowing air reservoirs, for example blowing air ring channels and in particular the reservoirs for pre-blowing (P1) and intermediate blowing (PI), are applied with fixed offset values, i.e. correction values, in order to achieve the exact pressure level in a certain operating state. Preferably, these correction values are added to the target values.

In the state of the art, the problem sometimes arises that there are certain operating states in which the actual reservoir pressure, for example an actual ring channel pressure, deviates from a target value. This can occur in particular at low pressure levels (in particular at pressures lower than 6 bar).

Furthermore, the correction value also partly depends on the preforms used or other parameters, such as BPHC (bottles per hour per cavity) and pressure. However, this means that the correction value is generally not a grade parameter. This means that the correction value is not always ideal for all operating states and also not all containers.

Furthermore, valuable recycling potential can remain unused during regular operation. In this way, air consumption is often significantly higher than it could be. In concrete examples, despite correct offset settings, pressure consumption was approx. 25% higher than it could theoretically be.

The present invention is therefore based on the object of making such apparatuses for forming plastic preforms into plastic containers more efficient.

### SUMMARY OF THE INVENTION

In a method according to the invention for forming plastic preforms into plastic containers by at least one apparatus for forming plastic preforms into plastic containers, plastic preforms are applied with a flowable and in particular gaseous medium, preferably compressed air, and thus formed into the plastic containers. Here, the plastic preforms are applied with different pressure levels and the flowable medium is stored in at least two reservoirs and preferably a plurality of reservoirs, in particular ring channels, and is supplied from these reservoirs to the plastic preforms, wherein at least one of these reservoirs is supplied with the flowable medium by a pressure supply device and wherein at least at times the flowable medium is returned from the plastic container to at least one of these reservoirs.

Here, a pressure in at least one reservoir is controlled, wherein a target pressure is compared with an actual pressure in this reservoir, and a value characteristic of this comparison is determined. According to the invention, at least one first control variable and at least one second control variable are controlled on the basis of this characteristic value, wherein the at least one first control variable and the at least one second control variable are controlled in a prioritized manner.

In this context, prioritized control is understood to mean that either the at least one first control variable is preferably controlled before the at least one second control variable or vice versa, in particular depending on further influencing factors, as described in more detail below.

Preferably, the pressure to be controlled in the at least one reservoir is the controlled variable of a control loop. Preferably, the target pressure is a reference variable of this control loop. Preferably, the actual pressure is an actual value of the controlled variable. Preferably, the characteristic value corresponds to a control difference, particularly a deviation of the actual value of the controlled variable from the reference variable. Advantageously, the characteristic value for the comparison is a difference between the actual pressure and the target pressure or a ratio between the actual pressure and the target pressure. Preferably, the at least one reservoir is a ring channel and particularly preferably a plurality of reservoirs is designed as a ring channel.

Preferably, the pressure of the flowable medium in the reservoir and/or the supply of the flowable medium from the pressure supply device to the reservoir is also controlled and, in particular, controlled as a function of an operating state of the apparatus. Preferably, the flowable medium is at least temporarily returned from the container to at least one pressure reservoir (this process is also referred to as recycling in the following).

Controlling the pressure in the at least one reservoir is understood to mean, in particular, that the supply of the flowable medium from the pressure supply device to the reservoir is controlled or regulated and/or the supply of the flowable medium from a finished plastic container to the reservoir (return of flowable medium, recycling) is controlled or regulated.

When the flowable medium is supplied into the at least one reservoir, the target pressure is typically not reached exactly, at least temporarily. In principle, two situations are possible here, namely that the pressure in the reservoir is temporarily higher than the target pressure after the supply of flowable medium (this is referred to as overfilling the reservoir) or lower than the target pressure (this is referred to as underfilling the reservoir). In the following, the terms overfilling and underfilling or underfilled or overfilled reservoir are used for these two situations.

Preferably, the at least one reservoir in which the pressure is regulated can be in an underfilled state or an overfilled state, at least temporarily. Preferably, in an underfilled state, the current pressure (actual pressure) is lower than a target pressure and particularly preferably, in an overfilled state, the current pressure (actual pressure) is higher than the target pressure.

Typically, the flowable medium, in particular pressurized air, is provided via a pressure supply device, for example a single-stage or multi-stage compressor, and reduced to the respective pressure of the reservoirs via one or more reducing devices. The pressure supply device can preferably be a compressor, but also for example, a pressure connection in a factory hall. Particularly preferably, the supply of pressure is controlled by a control device. This can be, for example, a so-called dome pressure regulator.

In a preferred method, the control target is to minimize the pressure difference between the actual value of the pressure (actual pressure) and the target pressure and preferably to maintain a constant pressure level (as far as possible). In other words, the control target is to keep the pressure in at least one reservoir constant and to keep the extent of fluctuations during (re-) adjustment as small and short as possible.

In order to maintain the desired pressure in the reservoir, for example after part of the flowable medium has been discharged to form a plastic preform into a plastic container, it is known in the prior art to add a correction value (offset value) to the pressure provided by the pressure supply device, which enables the pressure in the reservoir to be regulated to the desired pressure (target value). For example, a pressure of 10 bar is to be reached in the reservoir and the pressure supply device provides the flowable medium at a pressure of 10.2 bar. The offset value here is 0.2 bar. Such an offset value is typically specified in the prior art and is not variable or adaptable.

It is known from the applicant's internal prior art, in particular from the unpublished DE 10 2022 122 880 A1, to control such an offset value as a function of a deviation of the actual pressure from a target pressure and to use it as a control variable for controlling the pressure in the at least one reservoir. With such a regulation, however, recycling of the flowable medium is only insufficiently taken into account and the existing recycling potential is not fully utilized.

It is therefore proposed in the context of the present invention to control the pressure in the at least one reservoir as a function of at least two control variables, namely by adjusting the offset value (first control variable) and by adjusting a recycling time (second control variable), in particular as a function of an operating state of an apparatus for forming plastic preforms into plastic containers.

In an advantageous method, the at least one first control variable is an offset value of a pressure, which is added to the pressure provided by the pressure supply device and, in particular, to the pressure provided by a reducing device.

Advantageously, the pressure in the at least one reservoir is controlled as a function of an operating state of the apparatus, wherein preferably at least two operating states and preferably at least three operating states are defined.

Advantageously, the at least one first control variable and/or the at least one second control variable is controlled as a function of a predetermined operating state of the apparatus, wherein at least two and preferably at least three operating states of the apparatus are predetermined and wherein the control of the at least one first control variable and/or the at least one second control variable is prioritized in at least one predetermined operating state of the apparatus.

Preferably, the pressure in the at least one reservoir is regulated as a function of the operating state. Preferably, a first operating state is provided in which no manufacturing of plastic containers takes place. This can preferably be a standby mode or standby state in which no flowable medium is removed from the at least one reservoir. For example, there is a situation in which the apparatus is being ventilated, the last blowing process has been carried out and/or the system continues to rotate in standby mode without any further containers being produced.

Preferably, in the first operating state, the pressure in the at least one reservoir is controlled unilaterally, in particular by approaching the target pressure on one side starting from a pressure lower than the target pressure. In other words, the pressure is only controlled “from below” by varying the first control variable (offset value). If the reservoir is initially underfilled, the first control variable is adjusted, for example the offset value is increased by 0.2 bar. Preferably, the at least one first control variable is adjusted at intervals, preferably at a predetermined or predeterminable time interval. It is conceivable, for example, that an adjustment is made every 10 seconds.

If the reservoir is overfilled, for example, the at least one first control variable can be lowered once by a determined value, for example by 0.2 bar, and the excess flowable medium can be discharged via a free blowing nozzle. Subsequently, the pressure can be adjusted again from below. Preferably, in the first operating state, the pressure in the at least one reservoir is controlled in a single stage (only one control variable).

Preferably, a second operating state is provided in which the manufacturing of plastic containers starts. Preferably, the pressure in the at least one reservoir is regulated in a single stage in the second operating state, preferably via a PID controller.

Preferably, at least one and preferably several reservoirs, which store the flowable medium under one or more intermediate blowing pressures (PI channels), are successively filled in the second operating state, while only flowable medium under a pre-blowing pressure (P1) and under a final blowing pressure (P2) is used for the actual blowing process. Preferably, the PI channels are filled by returning the flowable medium (recycling). The production can start here without any compressed air recycling or so-called “air wizards (AW)”.

Preferably, the second operating state has several phases, in particular depending on the degree of filling of the PI channels. The PI channels are preferably filled in a first phase. A second phase is preferably present as long as the pressure level in the PI channels has not yet reached a constant level. As soon as the pressure level of the PI channels is constant, they can be switched on when the pressure builds up. In other words, a blowing process now takes place by supplying flowable medium under the pre-blowing pressure (P1), under at least one intermediate blowing pressure (PI) and the final blowing pressure (P2).

As soon as the pressure conditions in the reservoirs with the flowable medium are stable under one or more intermediate blowing pressures and a remaining pressure in at least one intermediate blowing channel (Pi1) is sufficiently high (pressure greater than P1) (phase 3), recycling into a reservoir under a pre-blowing pressure (P1) can take place and a change can be made from the third phase to the third operating state.

Preferably, a third operating state is provided in which the pressure in the at least one reservoir is controlled on the basis of the at least one first control variable and the at least one second control variable, for example by an AirWizard. Preferably, in a third operating state, the pressure in the at least one reservoir is regulated in two stages. The third operating state is preferably a working state, in particular a state of the apparatus in which constant manufacturing of containers takes place.

In a preferred method, the pressure in the at least one reservoir is controlled on the basis of the at least one first control variable (offset value) and the at least one second control variable. In an advantageous method, the at least one second control variable is a time, in particular a recycling time, within which the flowable medium is returned from the plastic container to at least one of these reservoirs.

Preferably, at least one first actuator is provided, which is assigned to the at least one first control variable. Preferably, the at least one first actuator is a valve of the pressure supply device, in particular of the reducing device, and particularly preferably, it is a proportional valve of a dome pressure regulator. Advantageously, the pressure in the at least one reservoir is regulated by means of a dome pressure regulator.

Preferably, at least one second actuator is provided, which is assigned to the at least one second control variable. Preferably, the at least one second actuator is a valve and in particular a proportional valve, which is open during the return of the flowable medium (recycling). Preferably, this is a valve in a valve arrangement for a forming station and particularly preferably a valve on a blowing nozzle.

In a preferred method, the at least one first control variable (offset value) is controlled in the respective operating states in such a manner that the target pressure in the at least one reservoir is achieved across all operating states and a constant pressure is present. By constant, it is understood that deviations over time are less than 20%, preferably less than 15%, preferably less than 10%, preferably less than 5% and particularly preferably, less than 3%.

In an advantageous method, the actual pressure is measured by means of a pressure measuring device and, in particular, a pressure measuring device arranged in the at least one reservoir. Preferably, the actual pressure is measured continuously. However, it would also be conceivable to measure the actual pressure temporarily, for example, at predetermined time intervals. A pressure measurement in a connection line to the reservoir would also be conceivable or several distributed pressure measuring devices.

Preferably, the pressure in the at least one reservoir is controlled as a function of an offset value (first control variable) and as a function of a recycling time (second control variable). Preferably, control is carried out via a two-stage regulator or in a two-stage control circuit. An advantageous embodiment is described in more detail below with reference to the attached figures.

In an advantageous method, a current offset value and/or a lower and/or an upper limit value of the offset value are taken into account when controlling the at least one first control variable. It is conceivable here that any offset value between two limit values can be selected, in particular automatically, wherein these limit values are predetermined or predeterminable and/or can be entered by an operator of the apparatus.

In a preferred method, a current recycling time and preferably a maximum possible recycling time are determined. A recycling time is understood here to be the time during which a valve is open for returning the flowable medium from the forming device or from the finished blown plastic container into the at least one reservoir. Preferably, this involves recycling into the reservoir under the pre-blowing pressure (P1) and, particularly preferably, this (recycling) valve is a proportional valve. In an advantageous method, a current recycling time and/or a maximum recycling time are taken into account when controlling the at least one second control variable.

Preferably, the maximum recycling time is a predetermined and/or predeterminable value and, in particular, this value can preferably be adjusted and/or changed by a user/operator of the system and/or a manufacturer of the system. Preferably, a minimum recycling time is also predetermined or predeterminable. In a preferred method, the second control variable corresponds to the recycling time and preferably the amount of the second control variable is between the minimum and maximum recycling time.

Preferably, the at least one reservoir can at least temporarily be in an overfilled state or in an underfilled state. Preferably, the at least one first control variable and/or the at least one second control variable is controlled as a function of a state of the at least one reservoir. In an advantageous method, the at least one first control variable and the at least one second control variable are controlled as a function of one another and/or are dependent on one another.

In an advantageous method, the at least one first control variable and the at least one second control variable are controlled in a prioritized manner. In an advantageous embodiment, the prioritized control of the at least one first control variable and the at least one second control variable takes place as a function of an actual pressure in this reservoir. Advantageously, the at least one first control variable is controlled with priority as soon as the actual pressure in this reservoir is lower than the target pressure and/or the at least one second control variable is controlled with priority as soon as the actual pressure in this reservoir is higher than the target pressure.

In an advantageous method, a result of the prioritized control of the at least one first control variable and/or the at least one second control variable is evaluated, wherein the result is preferably an effect of the control on the actual pressure in said reservoir. In other words, it is possible to assess or evaluate the effect of a control intervention (control of the at least one first control variable and/or control of the at least one second control variable) on the current pressure in the reservoir (actual pressure). It is conceivable that such a result or the evaluation of such a result can be output to the operator of the apparatus and/or can be used for controlling and/or regulating the apparatus.

It is known from the applicant's internal prior art that when changing from an operation without recycling (in accordance with the second operating state) to an operation with recycling (in accordance with the third operating state), it is necessary for the air recovery to regulate itself first. In this case, both a control circuit of the pressure supply device and a control circuit of the recycling system access the same measurement variable (the actual pressure in the pressure reservoir), wherein preferably one of the two actuators is controlled. The proportional valve of the pressure supply device is preferably used here.

During the transition to the recycling mode, for example, the current first control variable of the proportional valve (offset value) is controlled by a predetermined value, for example −0.3 bar (preferably a value between −0.1 and −0.8) and preferably controlled downwards. As a result, the ring channel pressure drops slightly. A recycling regulator preferably becomes active and reacts, in particular, immediately with an increase in the recycling period.

A ring channel pressure preferably equalizes again to the target pressure level. This process is then preferably repeated several times, in particular, until the lowering of the proportional valve once or twice in succession has no longer led to a further pressure drop.

However, this procedure does not allow any conclusions to be drawn as to whether a recycling potential has already been fully utilized or whether this is causing underfilling or overfilling of the reservoir.

Therefore, the present invention proposes to combine the two control circuits in order to improve the control of the pressure and to be able to exploit the recycling potential even better. An overview of such a coupled control loop is shown in FIG. 4 and is described in detail below.

A distinction must be made here as to whether the reservoir is temporarily underfilled or overfilled. First, the situation of an underfilled reservoir is described. If the pressure measurement shows that the reservoir is underfilled, it is preferable to determine in one step whether a maximum recycling time has already been set. If this is the case, the operator of the system can be informed of this and, if necessary, whether the value of the maximum recycling time could/should be increased (manually). To raise the pressure again, the system reacts by increasing the offset value (first control variable). If, however, it is determined that the recycling time is not yet maximum, this can be increased by a certain amount, for example by 1 ms. If this adjustment leads to an increase in pressure (Δ bar per Δ time), there was still recycling potential and the control loop can start again. However, if no increase in pressure is recognizable here, the recycling potential is exhausted and the offset value is increased again.

If the pressure measurement shows that the reservoir is overfilled, the offset is first lowered by a certain amount. If this leads to a pressure drop (Δ bar per Δ time), this means that the reservoir is fed by the pressure supply device and the control loop can start again from the beginning. If, on the other hand, no pressure drop is registered, this means that no compressed air is being supplied via the pressure supply device, but the recycling time is too long. The offset is therefore increased again by the same value and, in a further step, the recycling time is reduced and the control loop is restarted from the beginning.

This two-stage control circuit and, above all, the interlocking of the originally separate control circuits offers the advantage that the maximum recycling potential can be utilized and the consumption of flowable medium can be reduced overall.

Preferably, these determined and in particular optimized offset values (first control variable) and/or the determined and in particular optimized recycling times (second control variable) are stored as non-editable type parameters on a storage device and preferably these values can be reloaded as start values. This offers the advantage that a teach-in phase is largely eliminated or is only required again if significant process parameters are changed.

Particularly preferably, the pressure in the reservoir is regulated by means of a so-called dome pressure regulator. This can be connected between the pressure supply device and the respective pressure reservoir. In a preferred embodiment, the flowable medium is distributed to the pressure reservoir or reservoirs by a distribution device and, in particular, by a rotary distributor and/or applied with it.

Particularly preferably, at least at times, a portion of the flowable medium is recycled from one reservoir and/or the container to be expanded into another (pressure) reservoir or is (re) fed into it. Particularly preferably, there are several reservoirs and recycling takes place in this operating state.

In an advantageous method, the pressure supply device is controlled with regard to the amount of pressure it outputs and/or the pressure provided by the pressure supply device is reduced to the respective reservoir pressure by a reducing station.

The present invention is further directed to an apparatus for forming plastic preforms into plastic containers with at least one forming station which, by an application device, applies plastic preforms with a flowable and in particular gaseous medium, preferably with pressurized air, and thus forms them into the plastic containers. Furthermore, the forming station applies the plastic preforms with different pressure levels, wherein the apparatus has at least a first reservoir for storage of the flowable medium under a first pressure and a second reservoir for storage of the flowable medium under a second pressure and at least one supply device is provided, which supplies the flowable medium from these reservoirs to the plastic preforms and at least temporarily returns the flowable medium from the plastic containers to at least one of these reservoirs.

Furthermore, a pressure supply device is provided, which supplies at least one of these reservoirs with the flowable medium, wherein the pressure in at least one reservoir can be regulated, and wherein a target pressure can be compared with an actual pressure in this reservoir, and a value characteristic of this comparison can be determined.

According to the invention, the pressure output by the pressure supply device is controllable and/or the apparatus has a reducing station which regulates the pressure supplied to this reservoir by the pressure supply device.

Preferably, the apparatus may also have a control device, which regulates the pressure supplied to this reservoir by the pressure supply device and/or the supply of the flowable medium from the pressure supply device to the reservoir and/or the return of the flowable medium from the plastic container to the at least one reservoir. In particular, this control device is suitable and intended to control and/or regulate the first reservoir with the first pressure and/or the pressure to the first reservoir in which the lowest pressure is stored. Preferably, the control device is suitable and intended to control a pressure on the basis of the first control variable and/or the second control variable.

Preferably, the apparatus comprises a movable and, in particular, a rotatable carrier. Particularly preferably, several forming stations are arranged on this carrier. These preferably each have blow molds within which the forming takes place.

Particularly preferably, a valve device, and in particular a valve block, is associated with each forming station, which in turn has a plurality of valves in order to apply different pressures to the plastic preforms. Preferably, each forming station also has a stretching rod, which can be inserted into the plastic preforms in order to stretch them in their longitudinal direction. Preferably, several supply lines are provided, which connect several reservoirs with the forming stations and, in particular, with the valve devices.

Particularly preferably, a distribution device is provided, which distributes the flowable medium provided by the pressure supply device to the individual reservoirs and thus ultimately also to the individual forming stations. Particularly preferably, the pressure supply device is of stationary design.

In an advantageous embodiment, the apparatus and, in particular, the pressure supply device has at least one first actuator, which outputs at least one first control variable, wherein the at least one first actuator is a dome pressure regulator for the reducing station and, in particular, a proportional valve of the dome pressure regulator and/or the reducing station and wherein the at least one first control variable is a pressure (control pressure, preferably control pressure for the dome pressure regulator) of the flowable medium provided by the reducing station.

In an advantageous embodiment, the apparatus has at least one second actuator, which outputs at least one second control variable, wherein the at least one second actuator is a valve of the valve arrangement of the forming station and wherein the at least one second control variable is a time, in particular a recycling time, within which the flowable medium is returned from the plastic container to at least one of these reservoirs.

Particularly preferably, the apparatus also has at least a third pressure reservoir and preferably also at least a fourth pressure reservoir. Particularly preferably, at least one of these pressure reservoirs and preferably several pressure reservoirs are designed as ring channels, which are arranged in particular on the above-mentioned rotatable carrier.

Particularly preferably, the control device controls and, in particular, regulates the pressure supplied to the reservoir as a function of an operating state of the apparatus.

Particularly preferably, the flowable medium can be (re) guided at least temporarily from the container to be expanded or a second reservoir to the first reservoir. In this way, compressed air recycling can take place. Particularly preferably, at least one and preferably a plurality of valves are provided for carrying out this recycling.

In an advantageous embodiment, the forming station has a valve arrangement with a plurality of valves to apply the different pressure levels to the containers. Particularly preferably, at least one of these valves is a proportional valve.

Particularly preferably, the apparatus comprises at least one sensor device and, in particular, a pressure measuring device, which is associated with at least one pressure reservoir. Particularly preferably, this sensor device is suitable and intended for continuously determining a pressure within the reservoir. In a further advantageous embodiment, the apparatus also comprises a sensor device, which detects and, particularly preferably, continuously detects the pressure provided by the pressure supply device.

The control device is particularly preferably suitable for regulating the pressure taking into account a target pressure and preferably adding an offset pressure and in particular a variable offset pressure (first control variable) to this target pressure and/or regulating it by adjusting the recycling time.

In an advantageous embodiment, the apparatus has a comparison device, which is suitable for comparing a target pressure in a reservoir with an actual pressure in this reservoir and outputting a value characteristic of this comparison, and preferably a regulating device regulates the pressure in this reservoir based on this characteristic value. Particularly preferably, the offset (first control variable) is controlled in such a manner that the pressure in the reservoir is constant.

### BRIEF DESCRIPTION OF THE DRAWINGS

Further advantages and embodiments can be seen in the accompanying drawings:

In the drawings:

FIG. 1 shows a schematic representation of an apparatus according to the invention;

FIG. 2a, b show an overview of the operating modes in according to at least one embodiment of the method according to the invention;

FIG. 3 shows a schematic diagram of one embodiment of the method according to the invention.

### DETAILED DESCRIPTION OF THE INVENTION

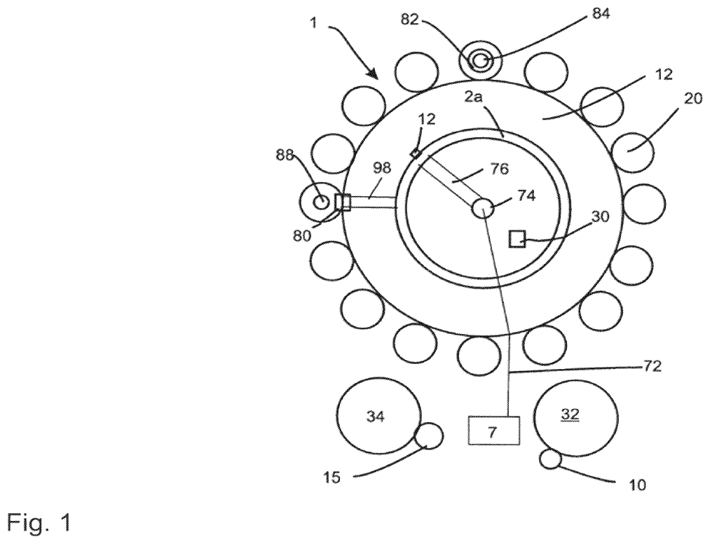

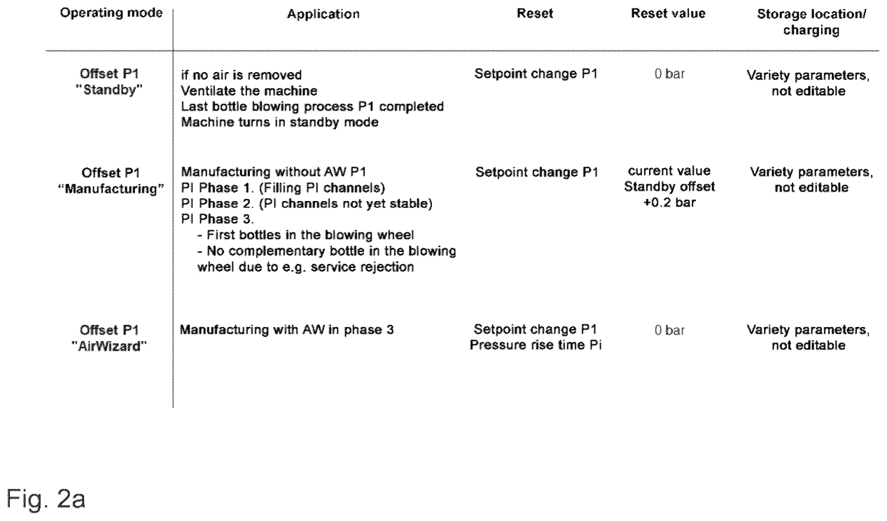

FIG. 1 shows an apparatus 1 for forming plastic preforms 10 into plastic containers 15. This apparatus has a rotatable carrier 12 on which a plurality of forming stations 20 is arranged. These individual forming stations each have blow molds 82 that form a cavity inside them for expanding the plastic preforms.

The reference sign 84 denotes an application device, which is used to expand the plastic preforms 10. This can be a blowing nozzle, for example, which can be applied to a mouth of the plastic preforms in order to expand the latter. Reference sign 80 denotes a valve arrangement, such as a valve block, which has a plurality of valves that control the application of different pressure levels to the plastic preforms.

In a preferred method, first a pre-blowing pressure P1, then one intermediate blowing pressure Pi that is higher than the pre-blowing pressure, and finally a final blow molding pressure P2 that is higher than the intermediate blowing pressure Pi are applied to the plastic preforms. After expansion of the plastic containers, the pressures or compressed air are preferably returned from the container to the individual pressure reservoirs.

The reference sign 88 denotes a stretching rod used to expand the plastic preforms in their longitudinal direction. Preferably, all forming stations have such blow molds 82 and stretching rods 88. The number of these forming stations is preferably between 2 and 100, preferably between 4 and 60, preferably between 6 and 40.

The plastic preforms 10 are fed to the apparatus via a first transport device 32, such as in particular but not exclusively a transport starwheel. The plastic containers 15 are transported away via a second transport device 34.

Reference sign 7 denotes a pressure supply device, such as a compressor or also a compressed air connection. The pressurized air is conveyed via a connecting line 72 and a reducing device 30 to a rotary distributor 74 and, from there, via a further line 76 to the reservoir 2a, which in this case is a ring channel.

In addition to such ring channel 2a shown, further ring channels are preferably provided, which are, however, concealed by, e.g., lie underneath, the ring channel 2a in the illustration shown in FIG. 1. The reference numerals 98 indicates a connecting line, which delivers the pressurized air to a forming station 20 or its valve block 80. Preferably, each of the ring channels is connected to all forming stations via corresponding connecting lines.

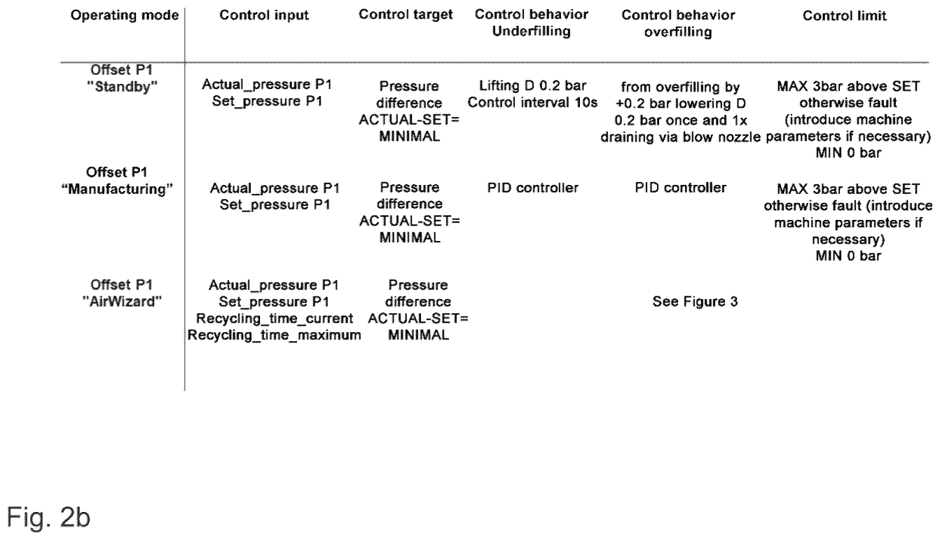

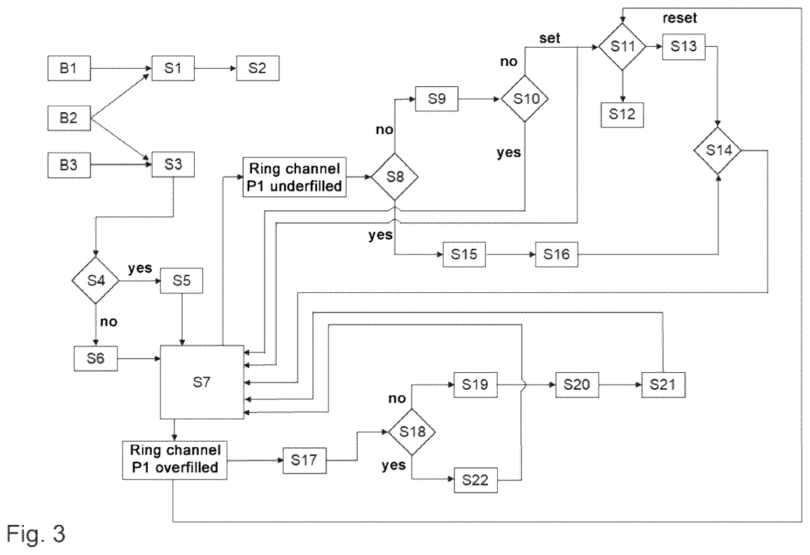

FIGS. 2a and 2b show an overview of three operating states of the present invention and of the control of the pressure ratios. In the following (for FIG. 3), all the relationships are described by way of example for a pressure reservoir or a ring channel under a pre-blowing pressure P1. It should be noted that this description is not a limitation of the present invention and can equally be transmitted to other pressure stages.

The first operating state “Offset P1 Standby” refers to a state of the system in which no air is being deposited, for example the apparatus is being ventilated, the last bottle to be produced has completed the blowing process with the pressure P1 or the apparatus is rotating in standby.

In a second operating state “Offset P1 Manufacturing”, the production of containers starts without using an AirWizard (AW, program for controlling and regulating pressurized air recirculation). The second operating state can be divided into three phases. In the first phase, “PI Phase 1”, the PI channels (ring channels under intermediate blowing pressures PI, Pi1, Pi2) are filled. Initially, the intermediate blowing channels Pi1 and Pi2 are empty when the apparatus starts up and are prefilled by recycling the pressurized air after the final blowing under pressure P2. In this phase, only the pressure levels P1 (pre-blowing pressure) and P2 (final blowing pressure) are used to blow the containers.

In a second phase, “PI Phase 2”, the intermediate blowing channels Pi1 and Pi2 are prefilled and, at the start of production, the pressure stage PI (intermediate blowing pressure) is used for blowing as well as recovery (recycling). The pressure stage PI is therefore activated between the pressure stages P1 and P2. A transition from “PI phase 1” to “PI phase 2” takes place as soon as the pressure is PI>X·P2, i.e. the pressure PI is greater than a predetermined fraction of the finished blowing pressure P2, preferably greater than one third of the final blowing pressure P2. Values between 10 and 80% of the final blowing pressure are also conceivable. If the pressure is Pi<X·P2, i.e. less than a specified fraction of the final blowing pressure P2, the apparatus remains in phase 1.

In a third phase, “PI Phase 3”, recycling is released into the P1 channel if the ring channel pressure Pi1, after it has become constant, is still greater than the pressure P1 and air can therefore be recovered. A transition from phase 2 to phase 3 takes place as soon as PI>X·P2, PI is constant and Pi1>P1. This phase occurs, for example, after the first containers have been blown.

In a third operating state “Offset P1 AirWizard”, the manufacturing of the containers takes place in accordance with phase 3 (see above) of the second operating state, wherein the regulation or control of the pressure conditions in pressure stage P1 takes place via the AirWizard.

The tables in FIGS. 2a and 2b show the individual parameters or steps for controlling the pressure ratios in P1 for the various operating states. In all cases, the control target is to minimize the pressure difference in the ring channel P1 between a specified target value and an actual value. In the first two operating states, the target value (predetermined value) and the actual value (measured value) are used as the control input, while in the third operating state, the recycling time, particularly an actual and a maximum (possible) recycling time, are also used as the control input. The recycling time is understood to be the time during which the valve for switching the P1 pressure stage is open in order to return or recycle compressed air from the container into the ring channel P1.

The respective control behavior depends on whether the corresponding ring channel is overfilled or underfilled. For example, in a first operating state “Offset P1 Standby”, the pressure can be raised by 0.2 bar in the event of underfilling, wherein a control interval of 10 s, for example, can be applied. In the event of overfilling, for example, the pressure can be lowered by 0.2 bar (once), and the pressure can be released once via the blowing nozzle, allowing the pressure to be readjusted from below. In an “Offset P1 manufacturing” operating state, the function of a PID regulator can be used for both underfilling and overfilling.

FIG. 3 shows a schematic sequence of an embodiment of the method according to the invention, in particular a control circuit for controlling the pressure in the ring channel P1 in the third operating state.

Depending on which of the conditions B1, B2, B3 are fulfilled, the method continues with step S1 or S3. The prerequisite for both steps is condition B2, namely that the pressures in the PI ring channels (in particular Pi1 and Pi2) are constant. If the pressure Pi1 is less than P1, the apparatus remains in phase 2 described above in a step S1, wherein the operating mode “Offset P1 Standby” is selected or maintained in a step S2.

If the pressure Pi1 is greater than P1 (condition B3 fulfilled), the system switches to phase 3 described above in step S3. In a step S4, it is determined whether the value of the “Offset AirWizard” parameter (hereinafter referred to as “Offset AirWizard”) is greater than or equal to the value of the “Offset Manufacturing” parameter (hereinafter referred to as “Offset Manufacturing”) of −0.3 bar. If this is the case, the offset AirWizard is set to the offset manufacturing value, namely −0.3 bar, in step S5. If this is not the case, a stored offset AirWizard is selected in step S6, which involves a one-off downward control, which is required to start the control process. In other words, this check checks or ensures that the Offset Air Wizard is at least 0.3 bar lower than the offset manufacturing. If this is the case, the offset values are not changed and are simply adopted or applied. However, if the offset is too high, it is reduced once to a level that is 0.3 bar below the current production offset. This ensures that the control can always start.

In both cases, the method is continued with step S7, wherein the pressure difference is checked, i.e. the deviation of the actual pressure from a target pressure (determination of the characteristic value). Two different situations are conceivable here. On the one hand, the measurement may show that the actual pressure is greater than the target pressure (“ring channel P1 overfilled” situation) or that the actual pressure is less than the target pressure (“ring channel P1 underfilled” situation).

First, the case in which the ring channel P1 is underfilled is described. In step S8, it is determined whether a recycling time is maximum. If this is not the case, the recycling time is increased by a certain amount in a step S9 (in the area of X ms, Δ+X ms, for example in the area of a few ms for small deviations X and in the area of 5 to 10 ms for large deviations X). If it is determined in a further step S10 that the pressure is increasing (detection Δ bar per Δ time), the method is continued with step S7, and it is determined again whether the ring channel P1 is overfilled or underfilled, and the control loop is continued accordingly.

If it is determined in step S10 that the pressure is not increasing, it is determined in step S11 whether there has been a change in the pressure conditions within the last 10 ms, in particular whether a pressure increase has been recorded. If this is not the case, the operator of the system can be informed in step S12, for example. This case can correspond to the situation where the recycling potential is exhausted (S13) and, in a further step S14 the offset AirWizard is raised by 0.1 bar (Δ+0.1 bar), and the method is continued with step S7 and the pressure difference is determined again. In this context, the term “set” in FIG. 3 between S10 and S11 means that a certain inertia of the system is taken into account, or that natural pressure fluctuations of the system are taken into account. The aim is to identify a “trend”, so to speak, which can then be responded to in the form of regulatory interventions. If this were not the case, the regulator would constantly and relatively chaotically change its control variables.

If, on the other hand, it is determined in step S8 that the recycling time already has a maximum value, it can be checked in step S15 whether there is any remaining recycling potential, and such information can be output to the operator in step S16. In the next step, the AirWizard offset is raised by +0.1 bar in step S14 as described above and the method is continued with step S7.

The next part now describes the situation in which it is determined in step S7 that the ring channel P1 is overfilled. In step S17, the AirWizard offset is lowered by 0.2 bar (Δ−0.2 bar). In a step S18, it is detected whether a pressure drop is recognizable (detection Δ bar per Δ time). If this is the case, it can be concluded that the overfilling of the P1 ring channel is caused by the dome controller (and therefore the AirWizard offset was set too high, S22), and the method can be continued with step S7.

If no pressure drop is recognizable in step S18, this means that the overfilling is not caused by the dome regulator but by recycling (S19). In a step S20, the AirWizard offset is adjusted back (Δ+0.2 bar) and, in a further step S21, the recycling time is reduced (in the area of X ms, Δ−X ms, for example in the area of a few ms for small deviations X and in the area of 5 to 10 ms for large deviations X).

The control loop in FIG. 3 also shows a connection between “ring channel P1 overfilled” and S11 with the term “reset”. As already explained above, the inertia of the system is taken into account here, i.e. (minimal) pressure fluctuations are defined to which the regulator does not yet have to react.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 apparatus
2a reservoir
7 pressure supply device
10 plastic preform
12 rotatable carrier
15 plastic container
20 forming station
30 reducing station
32 first transport device
34 second transport device
72 connecting line
74 rotary distributor
76 further line
80 valve arrangement
82 blow mold
84 application device
88 stretching rod
98 connecting line
B1 condition 1, Pi1<P1
B2 condition 2, PI pressures stable
B3 condition 3, Pi1>P1
S1 machine remains in “Phase 2”
S2 selection or retention of “manufacturing” offset
S3 switching to “Phase 3”
S4 offset AirWizard>=offset manufacturing 0.3 bar
S5 offset AirWizard=offset manufacturing-0.3 bar
S6 selection of offset AirWizard as stored
S7 check pressure difference
S8 maximum recycling time?
S9 increase recycling time Δ+(variable) ms
S10 pressure increase recognizable (variable) bar per Δ time
S11 no change in the last 10 ms increase
S12 info to operator
S13 recycling potential exhausted
S14 raise offset AirWizard Δ+0.1 bar
S15 residual recycling potential may still exist
S16 info to operator
S17 lower offset AirWizard Δ−0.2 bar
S18 pressure drop recognizable Δ bar per Δ time
S19 no more fresh air via dome
S20 offset AirWizard back again Δ+0.2 bar
S21 reduce recycling time Δ−(variable) ms
S22 dome supports power supply P1

1. A method for forming plastic preforms into plastic containers by at least one apparatus for forming plastic preforms into plastic containers, wherein plastic preforms are applied with a flowable medium and are thus formed into the plastic containers, wherein the plastic preforms are applied with different pressure levels and the flowable medium is stored in at least two reservoirs and is supplied from these reservoirs to the plastic preforms, wherein at least one of these reservoirs is supplied with the flowable medium by a pressure supply device, and wherein at least temporarily the flowable medium is returned from the plastic container to at least one of these reservoirs, wherein a pressure in at least one reservoir is controlled, and wherein a target pressure is compared with an actual pressure in this reservoir, and a value characteristic of this comparison is determined,
wherein
at least one first control variable and at least one second control variable are controlled on the basis of this characteristic value, wherein the at least one first control variable and the at least one second control variable are controlled in a prioritized manner.

2. The method according to claim 1,
wherein
the at least one first control variable is an offset value of a pressure, which is added to the pressure provided by the pressure supply device.

3. The method according to claim 1,
wherein
the at least one second control variable is a time within which the flowable medium is returned from the plastic container to at least one of these reservoirs.

4. The method according to claim 1,
wherein
the prioritized control of the at least one first control variable and the at least one second control variable takes place as a function of an actual pressure in this reservoir.

5. The method according to claim 4,
wherein
the at least one first control variable is controlled with priority as soon as the actual pressure in this reservoir is lower than the target pressure and/or the at least one second control variable is controlled with priority as soon as the actual pressure in this reservoir is higher than the target pressure.

6. The method according to claim 1,
wherein
a result of the prioritized control of the at least one first control variable and/or the at least one second control variable is evaluated.

7. The method according to claim 1,
wherein
the at least one first control variable and/or the at least one second control variable is controlled as a function of a predetermined operating state of the apparatus, wherein at least two operating states of the apparatus are predetermined and wherein the control of the at least one first control variable and/or the at least one second control variable is prioritized in at least one predetermined operating state of the apparatus.

8. The method according to claim 1,
wherein
the actual pressure is measured by a pressure measuring device.

9. The method according to claim 1,
wherein
a current offset value and/or a lower and/or an upper limit value of the offset value are taken into account when controlling the at least one first control variable and/or a current recycling time and/or a maximum recycling time are taken into account when controlling the at least one second control variable.

10. The method according to claim 1,
wherein
the characteristic value for the comparison is a difference between the actual pressure and the target pressure or a ratio between the actual pressure and the target pressure and/or the pressure in the at least one reservoir is regulated by a dome pressure regulator.

11. The method according to claim 1,
wherein
the pressure supply device is controlled with regard to the amount of pressure it outputs and/or the pressure provided by the pressure supply device is reduced to the respective reservoir pressure by a reducing station.

12. An apparatus for forming plastic preforms into plastic containers with at least one forming station which, by an application device, applies plastic preforms with a flowable medium and thus forms them into the plastic containers, wherein the forming station applies the plastic preforms with different pressure levels, wherein the apparatus has at least a first reservoir for storing the flowable medium under a first pressure and a second reservoir for storing the flowable medium under a second pressure and at least one supply device is provided, which supplies the flowable medium from these reservoirs to the plastic preforms and at least temporarily returns the flowable medium from the plastic containers to at least one of these reservoirs, and furthermore a pressure supply device is provided, which supplies at least one of these reservoirs with the flowable medium, wherein the pressure in at least one reservoir can be regulated, and wherein a target pressure is comparable with an actual pressure in this reservoir, and a value characteristic of this comparison can be determined,
wherein
the pressure output by the pressure supply device can be controlled and/or the apparatus has a reducing station, which regulates the pressure supplied to this reservoir by the pressure supply device.

13. The apparatus according to claim 12,
wherein
the apparatus has at least one first actuator, which outputs at least one first control variable, wherein the at least one first actuator is a dome pressure regulator of the reducing station and wherein the first control variable is a pressure of the flowable medium provided by the reducing station.

14. The apparatus according to claim 12,
wherein
the forming station has a valve arrangement with a plurality of valves in order to apply different pressure levels to the containers, and the apparatus has at least one second actuator, which outputs at least one second control variable, wherein the at least one second actuator is a valve in the valve arrangement of the forming station and wherein the at least one second control variable is a time within which the flowable medium is returned from the plastic container into at least one of these reservoirs.

15. The apparatus according to claim 12,
wherein
the apparatus has a comparison device, which is suitable for comparing a target pressure in a reservoir with an actual pressure in this reservoir and for outputting a value characteristic of this comparison.
